(19) United States
(12) Patent Application Publication
(10) Pub. No.: US 2019/0340614 A1
(43) Pub. Date: Nov. 7, 2019

(54) COGNITIVE METHODOLOGY FOR SEQUENCE OF EVENTS PATTERNS IN FRAUD DETECTION USING PETRI-NET MODELS

(71) Applicant: International Business Machines Corporation, Armonk, NY (US)

(72) Inventors: Thomas T. Hanis, Raleigh, NC (US); Eugene I. Kelton, Mechanicsburg, PA (US); Yi-Hui Ma, Mechanicsburg, PA (US); Willie R. Patten, JR., Hurdle Mills, NC (US)

(21) Appl. No.: 15/971,943

(22) Filed: May 4, 2018

(51) Int. Cl. G06Q 20/40; G06K 9/62; G06F 17/50

(52) U.S. Cl. CPC G06Q 20/4016; G06K 9/6215; G06F 17/5013; G06K 9/6269; G06K 9/6256; G06K 9/6218

(57) ABSTRACT

A cognitive system relies on a pattern library having pattern images with known risk scores to detect potential fraud. Each pattern image begins with a Petri-net model for historical events. A state space representation is generated based on the Petri-net model, and an event pattern layer is established using event sequence vectors from the state space representation. An aggregator layer is also established. The pattern image is created from the event pattern layer and aggregator layer, while applying iterative clustering on the vectors to combine similarities into patterns. A risk score is assigned using supervised or unsupervised learning. The same methodology is used to generate a current pattern image for current events to be analyzed. The cognitive system provides a current risk score based on risk scores associated with likely matches (not necessarily exact) from the pattern library. If the current risk score exceeds a threshold, appropriate action is taken.

### CROSS-REFERENCE TO RELATED APPLICATION

This application is related to U.S. patent application Ser. No. ______ entitled “COGNITIVE METHODOLOGY FOR SEQUENCE OF EVENTS PATTERNS IN FRAUD DETECTION USING EVENT SEQUENCE VECTOR CLUSTERING” (attorney docket no. P201705464XUS01) filed concurrently herewith, which is hereby incorporated.

### BACKGROUND OF THE INVENTION

### Field of the Invention

The present invention generally relates to fraud detection, and more particularly to a method of using a cognitive system to detect and react to potential fraud.

### Description of the Related Art

Fraud detection has become a special form of technology. Some of the most common applications of fraud detection are for credit card fraud, bank fraud, welfare fraud, and insurance fraud. The stakes in these areas are extremely high. A recent study showed that merchants in the United States alone lost nearly 200 billion dollars in a single year to credit card fraud.

Fraud appears in many different forms and the detection of fraud relies on a system with the capability to recognize or discover these fraudulent activities/events. Events occur within time and space, usually at predictable occurrences. This allows traditional fraud detection logic to build fixed rules such as the following.

### Car Insurance Fraud Example:

if an accident happens immediately before a policy is to expire, fraud risk is 10%; and five or more payment inquiry calls in two days, fraud risk increases to 50%; and body shop chosen for repairs is involved in ten or more investigation cases, fraud risk increases to 97%.

### Medical Fraud Example:

if a medical provider is performing uncommon expensive procedures referred by another provider, fraud risk increases to 25%;
and referring provider is on a watch list, fraud risk increases to 50%;
and rendering provider uses a shell billing company, fraud risk increases to 95%.

### Financial Fraud Example:

if an incoming wire transfer is followed by a similar outgoing wire transfer in a 14-day period, fraud risk increases to 50%;
and wire is followed by an out of country transfer, fraud risk increases to 90%; and that country is on suspect nation list, fraud risk increases to 99%.

### Bank Fraud Example:

if an account is opened within 30 days and is attempting to change address, fraud risk is 5%;
and two or more additional parties are being added to the account, fraud risk increases to 30%;
and ten or more cash deposits of $999 or less, fraud risk increases to 75%;
and ten or more cash withdrawals of $999 or less, fraud risk increases to 90%;
and request to close account, fraud risk increases to 99.9%.

### SUMMARY OF THE INVENTION

The present invention in at least one embodiment is generally directed to a method of detecting potential fraud by receiving a time-ordered series of historical events with associated characteristics, constructing a Petri-net model for the series of historical events wherein nodes of the Petri-net model correspond to the historical events, the characteristics are identified as pre-conditions or post-conditions by directed arcs toward or away from a given node, and nodes are separated by transitions, generating a state space representation of the series of historical events based on the Petri-net model, establishing an event pattern layer using event sequence vectors obtained from the state space representation, creating a pattern image for the series of historical events from the event pattern layer, assigning a risk score to the pattern image, storing the pattern image in association with the risk score in a pattern library, and using the pattern library to establish that a series of current events is potentially fraudulent. A current pattern image can similarly be generated for the series of current events, and the pattern library includes multiple historical pattern images each having an associated risk score and is used to train a cognitive system, so the cognitive system can provide a current risk score based on risk scores associated with one or more likely matches from the pattern library to the current pattern image, and the series of current events is determined to be potentially fraudulent responsive to a determination that the current risk score exceeds a predetermined threshold. The characteristics of the events can include a time, a location, an entity, and an amount. The pattern image can be generated by applying iterative cluster analysis on the event sequence vectors to combine similarities into patterns. An aggregator layer can also be used based on an aggregator associated with one of the characteristics, such as a customer, a geography, or an account. When fraud is detected, the system can respond by performing an action such as a notification, a denial, and a challenge.

The above as well as additional objectives, features, and advantages in the various embodiments of the present invention will become apparent in the following detailed written description.

### BRIEF DESCRIPTION OF THE DRAWINGS

The present invention may be better understood, and its numerous objects, features, and advantages of its various embodiments made apparent to those skilled in the art by referencing the accompanying drawings.

FIG. 1 is a block diagram of a computer system programmed to carry out fraud detection and reaction in accordance with one implementation of the present invention;

FIGS. 2A and 2B are Petri-net models (graphical representations) for exemplary customer transactions in accordance with one implementation of the present invention;

FIG. 3 is a table showing exemplary customer transactions to be modeled in accordance with one implementation of the present invention;

FIG. 4 is a Petri-net model for a 2-event sequence gleaned from the table of FIG. 3 in accordance with one implementation of the present invention;

FIG. 5 is a Petri-net model for a 4-event sequence gleaned from the table of FIG. 3 in accordance with one implementation of the present invention;

FIG. 6 is a table depicting a 4-event sequence state space representation for the table of FIG. 3 in accordance with one implementation of the present invention;

FIG. 7 is a pictorial representation of a pattern image generation process in accordance with one implementation of the present invention which combines an n-sequence of events layer and an aggregation layer, and performs clustering on the resulting application layer;

FIG. 8 is a pictorial representation of pattern matching in accordance with one implementation of the present invention wherein a current event pattern is associated with a pattern image from a pattern library having a known fraud risk score; and

FIG. 9 is a chart illustrating the logical flow for a fraud prevention process in accordance with one implementation of the present invention.

The use of the same reference symbols in different drawings indicates similar or identical items.

### DESCRIPTION OF THE PREFERRED EMBODIMENT(S)

Although current fraud detection techniques may work well in certain circumstances, there are still drawbacks to the rules-based approach described above. In particular, most of the statistical fraud detection techniques are built upon profile variables computed on historical data. These variables are usually measurement aggregated across certain periods of time, for example, the minimum/maximum/average of weekly transaction amounts, or the minimum/maximum/average of unique numbers of counterparties. In most examples, time is a fixed constant (daily, weekly, monthly) and not well equipped to handle the dynamic of event sequence and other temporal aspect associated with actual activities.

It would, therefore, be desirable to devise an improved method of fraud detection which could capturing dynamic and robust activity sequences and relationships to be able to quickly discover new and unusual fraud patterns that can't be identified through predefined rules. It would be further advantageous if the method could remain domain agnostic. The present invention achieves these and other advantages in various embodiments by incorporating sequence of events patterns and utilizing layered aggregation and machine learning pattern extraction techniques to detect potential frauds. A Petri-net graph can be used to represent the event with associated information such as where, who, how much, and when. It shows both the causal relationship between events and most importantly, the temporal aspect between events that is a critical element in many fraud detection applications. This approach does not rely on or explicitly use a rules engine. Instead, the invention makes use of the patterns found between events and the characteristics of those events.

The invention can leverage cognitive capabilities in detecting patterns that are unlike those seen prior and in learning whether those patterns illustrate fraudulent behavior and the ability to find other sets of events meeting these pattern characteristics. Cognitive systems are generally known in the art. A cognitive system (sometimes referred to as deep learning, deep thought, or deep question answering) is a form of artificial intelligence that uses machine learning and problem solving. A modern implementation of artificial intelligence is the IBM Watson™ cognitive technology. Models for scoring and ranking an answer can be trained on the basis of large sets of input data. The more algorithms that find the same answer independently, the more likely that answer is correct, resulting in an overall score or confidence level.

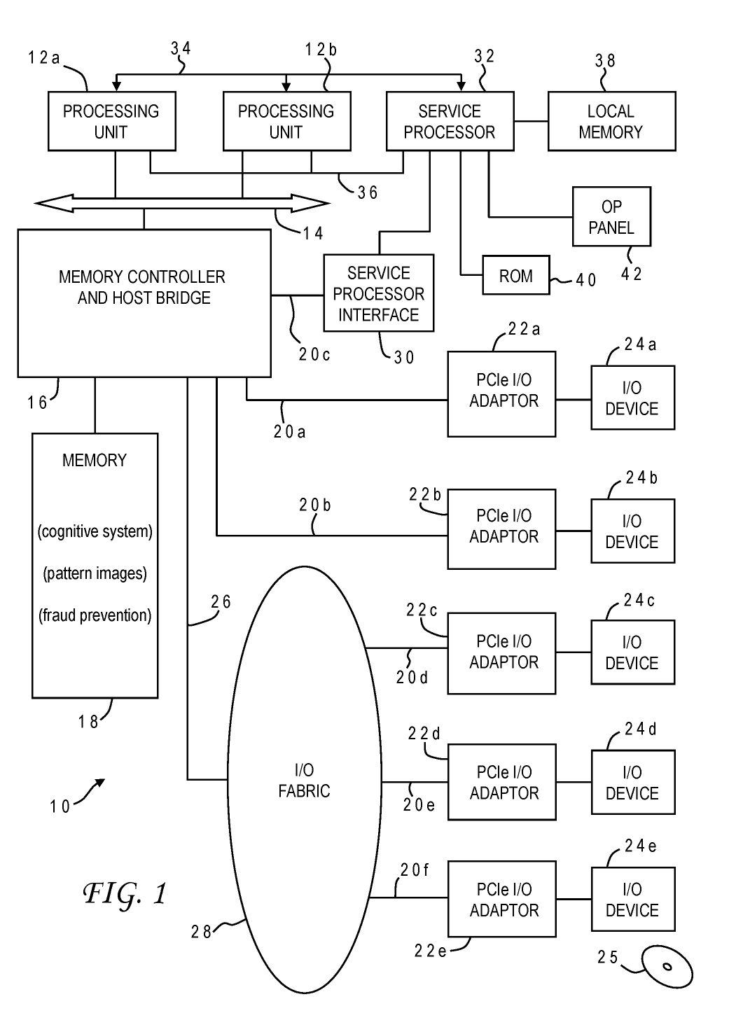

With reference now to the figures, and in particular with reference to FIG. 1, there is depicted one embodiment 10 of a computer system in which the present invention may be implemented to carry out fraud detection and response. Computer system 10 is a symmetric multiprocessor (SMP) system having a plurality of processors 12a, 12b connected to a system bus 14. System bus 14 is further connected to and communicates with a combined memory controller/host bridge (MC/HB) 16 which provides an interface to system memory 18. System memory 18 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches. System memory 18 has loaded therein a fraud detection and reaction application in accordance with the present invention, which may include a cognitive system and a pattern image library.

MC/HB 16 also has an interface to peripheral component interconnect (PCI) Express links 20a, 20b, 20c. Each PCI Express (PCIe) link 20a, 20b is connected to a respective PCIe adaptor 22a, 22b, and each PCIe adaptor 22a, 22b is connected to a respective input/output (I/O) device 24a, 24b. MC/HB 16 may additionally have an interface to an I/O bus 26 which is connected to a switch (I/O fabric) 28. Switch 28 provides a fan-out for the I/O bus to a plurality of PCI links 20d, 20e, 20f These PCI links are connected to more PCIe adaptors 22c, 22d, 22e which in turn support more I/O devices 24c, 24d, 24e. The I/O devices may include, without limitation, a keyboard, a graphical pointing device (mouse), a microphone, a display device, speakers, a permanent storage device (hard disk drive) or an array of such storage devices, an optical disk drive which receives an optical disk 25 (one example of a computer readable storage medium) such as a CD or DVD, and a network card. Each PCIe adaptor provides an interface between the PCI link and the respective I/O device. MC/HB 16 provides a low latency path through which processors 12a, 12b may access PCI devices mapped anywhere within bus memory or I/O address spaces. MC/HB 16 further provides a high bandwidth path to allow the PCI devices to access memory 18. Switch 28 may provide peer-to-peer communications between different endpoints and this data traffic does not need to be forwarded to MC/HB 16 if it does not involve cache-coherent memory transfers. Switch 28 is shown as a separate logical component but it could be integrated into MC/HB 16.

In this embodiment, PCI link 20c connects MC/HB 16 to a service processor interface 30 to allow communications between I/O device 24a and a service processor 32. Service processor 32 is connected to processors 12a, 12b via a JTAG interface 34, and uses an attention line 36 which interrupts the operation of processors 12a, 12b. Service processor 32 may have its own local memory 38, and is connected to read-only memory (ROM) 40 which stores various program instructions for system startup. Service processor 32 may also have access to a hardware operator panel 42 to provide system status and diagnostic information.

In alternative embodiments computer system 10 may include modifications of these hardware components or their interconnections, or additional components, so the depicted example should not be construed as implying any architectural limitations with respect to the present invention. The invention may further be implemented in an equivalent cloud computing network.

When computer system 10 is initially powered up, service processor 32 uses JTAG interface 34 to interrogate the system (host) processors 12a, 12b and MC/HB 16. After completing the interrogation, service processor 32 acquires an inventory and topology for computer system 10. Service processor 32 then executes various tests such as built-in-self-tests (BISTs), basic assurance tests (BATs), and memory tests on the components of computer system 10. Any error information for failures detected during the testing is reported by service processor 32 to operator panel 42. If a valid configuration of system resources is still possible after taking out any components found to be faulty during the testing then computer system 10 is allowed to proceed. Executable code is loaded into memory 18 and service processor 32 releases host processors 12a, 12b for execution of the program code, e.g., an operating system (OS) which is used to launch applications and in particular the fraud detection application of the present invention, results of which may be stored in a hard disk drive of the system (an I/O device 24). While host processors 12a, 12b are executing program code, service processor 32 may enter a mode of monitoring and reporting any operating parameters or errors, such as the cooling fan speed and operation, thermal sensors, power supply regulators, and recoverable and non-recoverable errors reported by any of processors 12a, 12b, memory 18, and MC/HB 16. Service processor 32 may take further action based on the type of errors or defined thresholds.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer system 10 carries out program instructions for a fraud prevention process that uses novel cognitive techniques to detect and response to potential fraud. Accordingly, a program embodying the invention may additionally include conventional aspects of various cognitive system tools, and these details will become apparent to those skilled in the art upon reference to this disclosure.

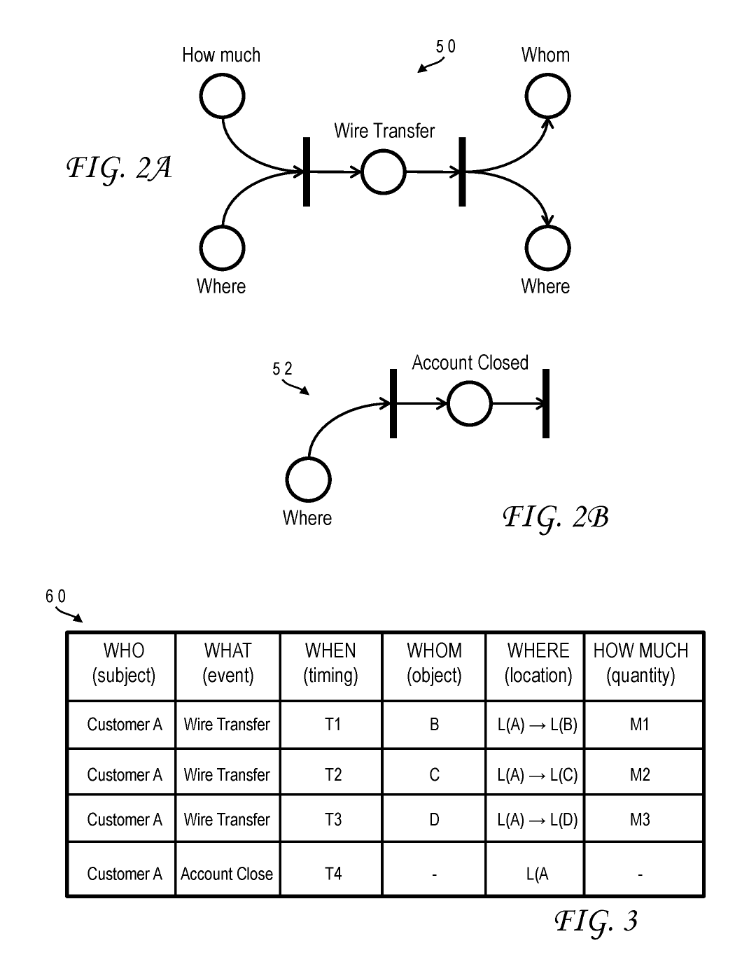

Referring now to FIGS. 2A and 2B, there are depicted graphical representations of domain specific events according to a Petri-net model. A Petri net, also known as a place/transition (PT) net, is a mathematical modeling language for the description of distributed systems. A Petri net is a directed bipartite graph, in which the nodes represent transitions (i.e., events that may occur) and characteristics or conditions, (e.g., places) represented by circles. The directed arcs describe which characteristics are pre- and/or post-conditions for which transitions; characteristics may include for example a time, a location and event meta-data. In this example, the events related to certain banking transactions. Events occur at time intervals; for example, accounts are opened, money transferred, and at some point the account would be closed. Understanding those intervals is the first step in using the order of these intervals in fraud detection. The present invention can build upon the Petri-net modeling language to capture the essential characteristic of sequence of events, where circles (places) represent resources and/or timed events and bars (transitions) indicate the start/end of activities. FIG. 2A is a Petri-net model 50 for a wire transfer. The pre-conditions to the wire transfer event include a quantity (“How much”) and a location (“Where”). The post-conditions include an entity (“Whom”), in this case, the recipient of the wire transfer, and another location (“Where”) of the recipient. FIG. 2B is a Petri-net model 52 for closing an account and includes only a location pre-condition.

Petri-net models can be built upon for more complicated sequences of banking events. The table 60 in FIG. 3 is an example of a transaction sequence for banking customer A, at a location L(A). This sequence includes three wire transfers followed by closing of the bank account. The first wire transfer occurs at a time T1, with an amount of money M1 being transferred to party B at a location L(B). The second wire transfer occurs at a time T2, with an amount of money M2 being transferred to party C at a location L(C). The third wire transfer occurs at a time T3, with an amount of money M3 being transferred to party D at a location L(D). The account is closed at time T4, associated only with the location of customer A.

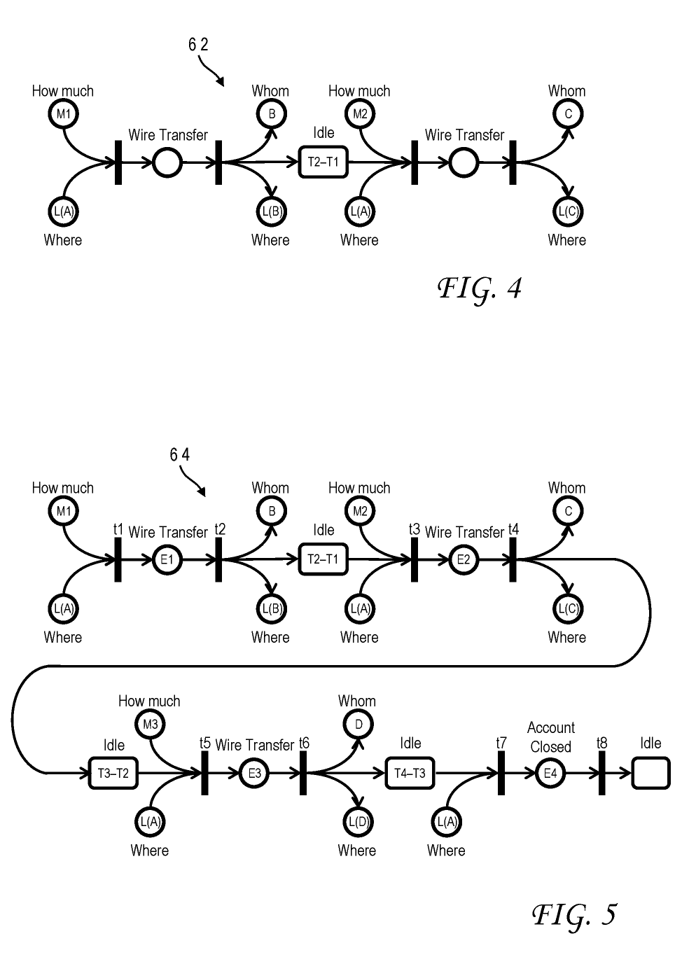

The transactions seen in table 60 can be considered as different sequences of events, i.e., n-sequence of events, where n for this example can be any integer value between 1 and 4, inclusive. FIG. 4 is a Petri-net model 62 (sequence of event representation with temporal information) for a 2-event sequence derived from the table 60. This representation 62 provides an understanding of how the events occur in relation to the idle times between them. Thus, in this 2-event sequence representation there are two Petri nets for each wire transaction, the first having pre-conditions M1 and L(A) and post-conditions B and L(B), the second having pre-conditions M2 and L(A) and post-conditions C and L(C) with an idle time of “T2−T1” between the two transfers. FIG. 5 shows a 4-event sequence 64 representation derived from table 60. The 4-event sequence 64 includes the various features of 2-event sequence 62, with additional Petri nets for the third wire transfer and the account closing. The third Petri net has pre-conditions M3 and L(A) and post-conditions D and L(D) with another idle time of “T3−T2” between the second and third wire transfers, and the fourth Petri net has only pre-condition L(A) with an idle time of “T4−T3” between the third wire transfer and the account closing.

Those skilled in the art understand that table 60 and the associated Petri-net models 62, 64 are relatively simple as they pertain to only four events in total, but the invention can consider sequences with much higher numbers of events. Additionally, this case is set in the banking domain but similar Petri-net models can be built for other domains as well so the wire transfer example should not be construed in a limiting sense. Other implementations may use different models for the state space representation, e.g., activity diagrams. Petri-nets are considered a preferred approach for discrete-event state space representation.

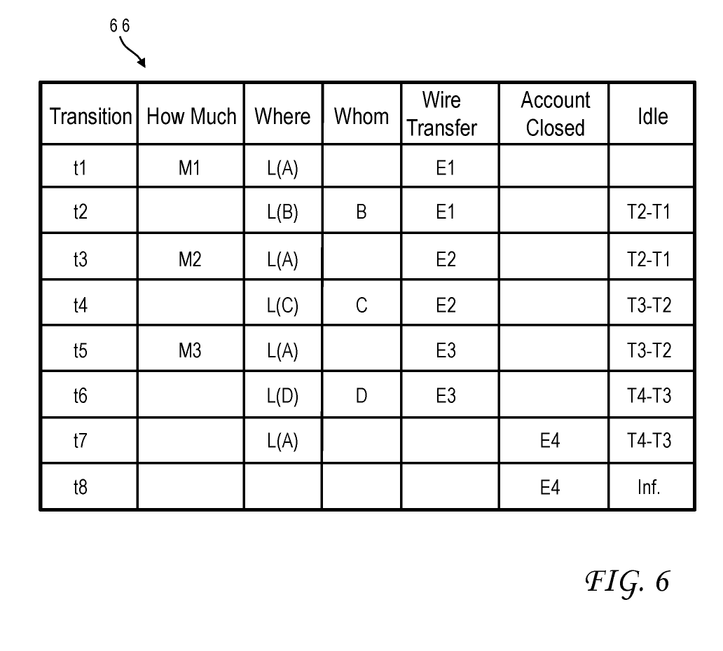

The novelty of the present invention lies in its ability to detect fraud over arbitrary time periods, independent of prescriptive rules or statistical methodologies, by using the patterns created across the events and their temporal and spatial characteristics. This ability is achieved through event sequence pattern recognition. The cognitive learning begins with knowledge representation for event sequences which can be used to form or simulate any potential fraud/non-fraud patterns. The building blocks for various potential fraud patterns are the state space representation of event sequences. The state space representation can be derived from the Petri-net graphical modeling and is intended to capture the important information associated with each event and the critical temporal aspect between events. FIG. 6 shows a table 66 for such a state space representation in the wire transfer example. Each event is associated with two transitions, there being a total of eight transitions t1, t2, . . . t8 for the 4-event sequence (corresponding to the bars of the Petri-net graph). Event sequence vectors can then be constructed for each n-event sequence by taking the entries of table 66 in order. For example, the vector associated with the first 1-event sequence of FIG. 5 (from transition t1 to transition t2) is:
(t1, t2)=[M1, L(A), 0, E1, 0, 0, 0, L(B), B, E1, 0, T2−T1].

The vector associated with the second 1-event sequence (from transition t3 to transition t4) is:
(t3, t4)=[M2, L(A), 0, E2, 0, T2−T1, 0, L(C), C, E2, 0, T3−T2].
   There are accordingly four separate 1-event sequences represented in FIG. 6, one for each event E1 through E4. There are also three 2-event sequences, two 3-event sequences, and one 4-event sequence. The first 2-event sequence includes events E1 and E2, the second 2-event sequence includes events E2 and E3, and the third 2-event sequence includes events E3 and E4. The first 3-event sequence includes events E1, E2 and E3, and the second 3-event sequence includes events E2, E3 and E4. The 4-event sequence includes all four of the events E1 through E4. Vectors (or matrices) can be constructed for each of these sequences, e.g., the matrix associated with the first 2-event sequence is:

$$( t 1 , t 4 ) = [ \begin{matrix}M 1 L ( A ) 0 E 1 \; 0 \; 0 \; 0 L ( B ) B E 1 \; 0 T 2 - T 1 \\ M 2 L ( A ) 0 E 2 \; 0 T 2 - T 1 \; 0 L ( C ) C E 2 \; 0 T 3 - T 2\end{matrix} ] .$$

The exact order of the components of the vector (i.e., the order of the columns in the state space representation table) and the particular values types are not critical, but the order should be temporally consistent with the Petri-net graph.

These building blocks can be combined through different layers of composition to create a dynamic image of various activity patterns. Subsequently through proper analytical model learning and training, these images can then be used to distinguish different potential fraudulent activities. Starting with the graphical modeling of the event sequence allows domain specific knowledge and the dependence between events to be included in the analysis. The resulting state space representation is a comprehensive image of the event occurrence over time and provides a unique way to build and predict activities patterns that can be used for fraud detection.

FIG. 7 illustrates how the state space representation can be combined with one or more aggregators to generate an application layer and, ultimately, a pattern image for an event sequence. According to this implementation, each pattern image is based on two layers, an n-sequence of event layer 70 and an aggregator layer 72. Aggregator layer 72 and n-sequence of event layer 70 together form the application layer 74. The n-event sequence layer 70 is a single layer that is used to capture a set of sequences. Thus, the n-sequence of event layer 70 includes multiple vectors, i.e., vectors for the 1-event sequences, vectors for the 2-event sequences, and so on, up to the maximum sequence dictated by the number of total events in the associated Petri-net graph for a series of related events (e.g., four sequences in the previous wire transfer and account closing example of FIG. 3). The aggregator layer 72 is based on any one of a number of potential aggregators, such as customer, account, location (GEO), etc. If for example the customer aggregator is selected for aggregator level 72, then the resulting application layer 74 will include only those sequences that have the same customer value (e.g., customer A). So for each different aggregator, there is a different set of sequence of events. In other words, the set of event sequences is built based on a particular aggregator, because different aggregators can yield different patterns.

The event sequences themselves could be used to characterize a pattern image for the activity/transactions but in the preferred implementation the different sets of sequences undergo a clustering procedure. Clustering is first applied to all of the 1-event sequence vectors in application layer 74. Clustering is based on the similarity of events in the vectors, e.g., all event sequence vectors having a wire transfer event would be clustered together. Similarity of events may be considered in terms of the event space, with distances between events. The distance can be calculated based on the distance between vectors within the state space. Clustering can thus optimize some distance calculation according to known techniques. Clustering can be iterative, such that the number of clusters or groups over successive iterations is reduced. In the example of FIG. 7, there are initially five clusters 76a of 1-event sequences, then four clusters 76b, and then three clusters 76c. The termination criteria for ending the clustering rounds can vary according to designer preference, according to known clustering techniques. In the illustrative implementation the criteria is to minimize the distances for events within the same cluster while maximizing the distances between clusters.

Each resulting group of the final clustering iteration is a representative pattern of a subset of the 1-event sequences. This clustering is repeated for the other n-event sequences, i.e., separate sets of representative groups are formed from the 2-event sequences, from the 3-event sequences, etc. These different sets of clusters are stored together as a matrix to form the pattern image 80. A resulting clustering is represented within pattern image 80 by calculating the centroid of the events within the cluster and a maximum radius.

The illustration in FIG. 7 of pattern image 80 is conceptual, with different shadings of the boxes representing different attributes of the sequence clusters. For example, one shading type might represent the frequency of a particular base element of the sequences (e.g., subject, event, timing, object, location, quantity, etc.) in a particular n-sequence cluster. A constructed pattern image can be assigned a risk score which provides a known indication of fraud potential. The risk score can for example be on a scale of 0-100 where 0 means complete safety and 100 means outright fraud. Risk scores can be learned from past experiences (e.g., based on population anomaly detection) and/or supervised learning with subject matter experts having experience with fraud cases. A pattern library can then be formed by collecting pattern images from a large number of activities over time, each having its associated risk score.

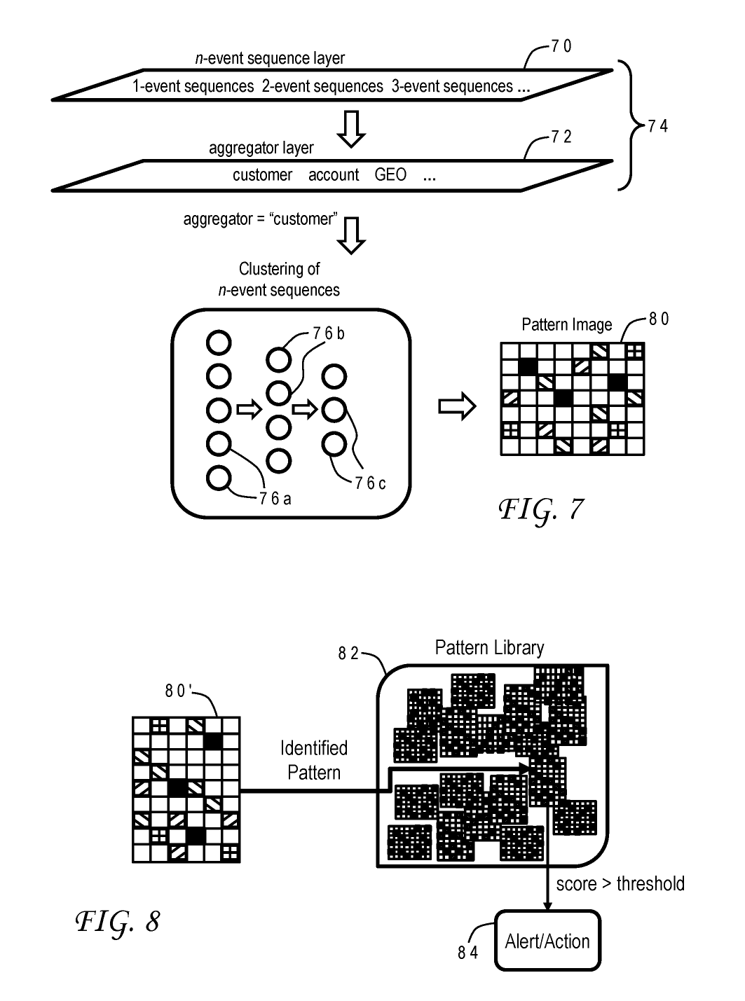

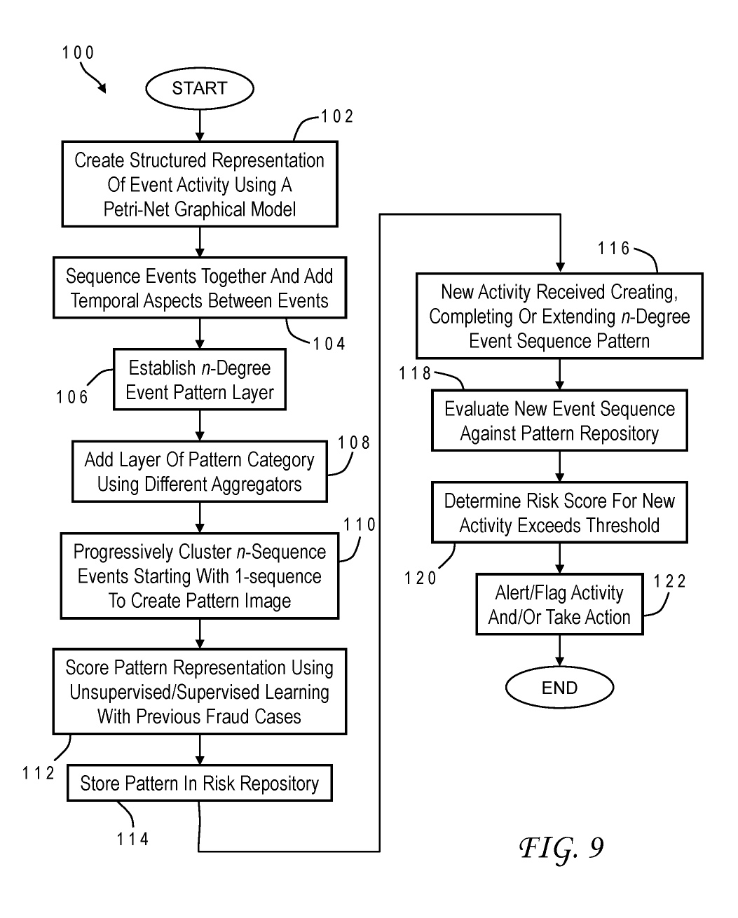

The pattern detection phase of the invention is shown in FIG. 8. A current pattern image 80′ is given as an input to a cognitive system which has been trained using a pattern library 82. The cognitive system may for example be running on computer system 10 of FIG. 1. Pattern image 80′ represents a current activity that is to be assessed for fraud potential. Pattern image 80′ is constructed in the same manner as the pattern images in the pattern library, as described above. This activity may be used to generate multiple pattern images (for example, based on different aggregators) and all of these current pattern images can separately be submitted to the cognitive system for analysis. The pattern images forming pattern library 82 can vary considerably accordingly to historical activities. As explained above, each pattern image in pattern library 82 has an associated risk score. The cognitive system can provide one or more likely matches from pattern library 82 to the current pattern image 80′, along with the risk score associated with the likely match. The candidate matches can also have confidence values generated by the cognitive system. The risk score of the most likely match can be used as the risk score of the current pattern image; alternatively, the risk score of the current pattern image can be a function of the risk scores from multiple candidate matches, e.g., a weight average wherein the weights applied to the respective risk scores are the confidence values, or some other combination of selected results. Other weightings can also be applied, for example, scores from older pattern images may be given less weight than scores from more recent pattern images.

Once the risk score is computed for the current pattern image, it can be compared to one or more threshold values to determine what response, if any, to take. In the simplest implementation a single threshold (e.g., 60 out of 100) will generate an alert/action 84 (FIG. 8), such as flagging the activity as suspicious and requiring further review by an analyst. In the preferred implementation, a banded approach is used with two threshold values. The lowest value (e.g., 50 out of 100) indicates that no action is needed at all when the current risk score is below this value. This value and a higher value (e.g., 80 out of 100) define a medium band for which analyst review is recommended. A risk score above the higher value would result in immediate initiation of corrective action such as notification (suspicious activity reporting), a denial of privileges (e.g., suspending a credit card account), or a challenge (e.g., sending a text message to a mobile electronic device associated with an owner of an account).

The present invention may be further understood with reference to the chart of FIG. 9 which illustrates the logical flow for a fraud detection and response process 100 using event sequence pattern recognition in accordance with one implementation of the present invention. Process 100, which may be carried out using computer system 10, begins by creating a structured representation of event activity or transactions; in this implementation the structured representation is derived from a Petri-net graphical model (102). Events are sequenced together (concatenated) in time order and other temporal aspects are added between events (104). For each graphical event modeling, a structured corresponding state space representation can be established, defining n-sequence of events as one layer of the pattern categorization (106). For each n-sequence event pattern layer, another layer of pattern category is added using different aggregators (108). Clustering is then applied to the n-sequence events, first for the 1-sequence event, to generate base elements of the sequence event, i.e., the constituents of the state space representation such as object, quantity, location, etc. (110). The 2-sequence event pattern can be built using the 1-sequence event vector and the resulting sparse square matrix. Similarly, the 3-sequence event pattern can be formed using the 2-sequence event matrix and 1-sequence event vector. This particular pattern image is then assigned a fraud risk score (112), and the pattern image is stored in the risk repository with the corresponding risk evaluation for subsequent batch or real-time scoring of event sequences as they materialize (114). The process might end here, but in FIG. 9 the application of the risk repository is additionally shown as part of the overall scheme. The computer system carrying out fraud detection receives new activity information which creates, completes or extends an activity record forming a current pattern image (116). Again, this activity information may be provided in real time or in a batch operation. Pattern detection is performed against each newly emerged sequence of events to obtain an evaluation against known risk patterns or to project unknown risk patterns that can be used in concert with other risk models to generate a current risk score (118). The new patterns can also be added to the pattern repository with updated risk evaluation for future use. The flow of process 100 is intended to show actual detection of potential fraud, so according to this flow when the current risk score is examined, the computer system determines that the risk score has exceeded some predetermined threshold (120). The system responsively takes action such as generating an alert or flagging an account, or more serious intervention (122).

The present invention thereby incorporates cognitive event learning into the fraud detection process such that, as fraudsters become increasingly sophisticated, the detection system learns and responds. The methodology described herein is domain independent and treats the events and characteristics about events in the same manner. This approach is also useful in learning new patterns that point to fraud and are not dependent on specific industries or links between theory (prescribed practice) and actual facts (treatments received).

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. While the invention is targeted against fraud detection, it has potential uses where there is a need to express events across arbitrary time sequences in order to perform pattern recognition of disparate events. It is therefore contemplated that such modifications can be made without departing from the spirit or scope of the present invention as defined in the appended claims.

What is claimed is:

1. A method of detecting potential fraud comprising:
receiving a time-ordered series of historical events with associated characteristics, by executing first program instructions in a computer system;
constructing a Petri-net model for the series of historical events wherein nodes of the Petri-net model correspond to the historical events, the characteristics are identified as pre-conditions or post-conditions by directed arcs toward or away from a given node, and nodes are separated by transitions, by executing second program instructions in the computer system;
generating a state space representation of the series of historical events based on the Petri-net model, by executing third program instructions in the computer system;
establishing an event pattern layer using event sequence vectors obtained from the state space representation, by executing fourth program instructions in the computer system;
creating a pattern image for the series of historical events from the event pattern layer, by executing fifth program instructions in the computer system;
assigning a risk score to the pattern image, by executing sixth program instructions in the computer system;
storing the pattern image in association with the risk score in a pattern library, by executing seventh program instructions in the computer system; and
using the pattern library to establish that a series of current events is potentially fraudulent, by executing eighth program instructions in the computer system.

2. The method of claim 1 further comprising generating a current pattern image for the series of current events, wherein the pattern library includes multiple historical pattern images each having an associated risk score and is used to train a cognitive system, the cognitive system provides a current risk score based on risk scores associated with one or more likely matches from the pattern library to the current pattern image, and the series of current events is determined to be potentially fraudulent responsive to a determination that the current risk score exceeds a predetermined threshold.

3. The method of claim 1 wherein the characteristics include at least a time, a location, an entity, and an amount.

4. The method of claim 1 wherein said creating the pattern image includes applying iterative cluster analysis on the event sequence vectors to combine similarities into patterns.

5. The method of claim 1 further comprising establishing an aggregator layer based on an aggregator associated with one of the characteristics, wherein the pattern image for the series of historical events is created from both the event pattern layer and the aggregator layer.

6. The method of claim 5 wherein the aggregator is selected from the group consisting of a customer, a geography, and an account.

7. The method of claim 1 further comprising performing an action in response to establishing that the series of current events is potentially fraudulent, the action selected from a group consisting of a notification, a denial, and a challenge.

8. A computer system comprising:
one or more processors which process program instructions;
a memory device connected to said one or more processors; and
program instructions residing in said memory device for detecting potential fraud by receiving a time-ordered series of historical events with associated characteristics, constructing a Petri-net model for the series of historical events wherein nodes of the Petri-net model correspond to the historical events, the characteristics are identified as pre-conditions or post-conditions by directed arcs toward or away from a given node, and nodes are separated by transitions, generating a state space representation of the series of historical events based on the Petri-net model, establishing an event pattern layer using event sequence vectors obtained from the state space representation, creating a pattern image for the series of historical events from the event pattern layer, assigning a risk score to the pattern image, storing the pattern image in association with the risk score in a pattern library, and using the pattern library to establish that a series of current events is potentially fraudulent.

9. The computer system of claim 8 wherein said program instructions further generate a current pattern image for the series of current events, the pattern library includes multiple historical pattern images each having an associated risk score and is used to train a cognitive system, the cognitive system provides a current risk score based on risk scores associated with one or more likely matches from the pattern library to the current pattern image, and the series of current events is determined to be potentially fraudulent responsive to a determination that the current risk score exceeds a predetermined threshold.

10. The computer system of claim 8 wherein the characteristics include at least a time, a location, an entity, and an amount.

11. The computer system of claim 8 wherein creating the pattern image includes applying iterative cluster analysis on the event sequence vectors to combine similarities into patterns.

12. The computer system of claim 8 wherein said program instructions further establish an aggregator layer based on an aggregator associated with one of the characteristics, and the pattern image for the series of historical events is created from both the event pattern layer and the aggregator layer.

13. The computer system of claim 12 wherein the aggregator is selected from the group consisting of a customer, a geography, and an account.

14. The computer system of claim 8 wherein said program instructions further perform an action in response to establishing that the series of current events is potentially fraudulent, the action selected from a group consisting of a notification, a denial, and a challenge.

15. A computer program product comprising:
a computer readable storage medium; and
program instructions residing in said storage medium for detecting potential fraud by receiving a time-ordered series of historical events with associated characteristics, constructing a Petri-net model for the series of historical events wherein nodes of the Petri-net model correspond to the historical events, the characteristics are identified as pre-conditions or post-conditions by directed arcs toward or away from a given node, and nodes are separated by transitions, generating a state space representation of the series of historical events based on the Petri-net model, establishing an event pattern layer using event sequence vectors obtained from the state space representation, creating a pattern image for the series of historical events from the event pattern layer, assigning a risk score to the pattern image, storing the pattern image in association with the risk score in a pattern library, and using the pattern library to establish that a series of current events is potentially fraudulent.

16. The computer program product of claim 15 wherein said program instructions further generate a current pattern image for the series of current events, the pattern library includes multiple historical pattern images each having an associated risk score and is used to train a cognitive system, the cognitive system provides a current risk score based on risk scores associated with one or more likely matches from the pattern library to the current pattern image, and the series of current events is determined to be potentially fraudulent responsive to a determination that the current risk score exceeds a predetermined threshold.

17. The computer program product of claim 15 wherein the characteristics include at least a time, a location, an entity, and an amount.

18. The computer program product of claim 15 wherein creating the pattern image includes applying iterative cluster analysis on the event sequence vectors to combine similarities into patterns.

19. The computer program product of claim 15 wherein said program instructions further establish an aggregator layer based on an aggregator associated with one of the characteristics, and the pattern image for the series of historical events is created from both the event pattern layer and the aggregator layer.

20. The computer program product of claim 19 wherein the aggregator is selected from the group consisting of a customer, a geography, and an account.
